(19) United States
(12) Patent Application Publication
(10) Pub. No.: US 2025/0059982 A1
(43) Pub. Date: Feb. 20, 2025

(54) TURBO MACHINE AND METHOD OF MANUFACTURING

(71) Applicant: Cryostar SAS, Hesingue (FR)

(72) Inventors: Stephane SGAMBATI, HESINGUE (FR); Séverin LAMBERT, HESINGUE (FR); David GALLAND, HESINGUE (FR)

(21) Appl. No.: 18/720,280

(22) PCT Filed: Dec. 13, 2022
(86) PCT No.: PCT/EP2022/025571

§ 371 Date: Jun. 14, 2024

(30) Foreign Application Priority Data
Dec. 20, 2021 (EP) 21315284.6

(51) Int. Cl. F04D 29/44; F04D 17/10

(52) U.S. Cl. CPC F04D 29/441; F04D 17/10

(57) ABSTRACT

A turbo machine with a shaft, an impeller arranged on said shaft, an inlet channel configured to guide operating fluid to said impeller, and an outlet channel configured to guide operating fluid from said impeller, wherein the turbo machine comprises an insulation component having two component parts separated from each other, at least in part, by a gap, wherein one of the two component parts forms part of or rests at a wall of said inlet channel, and the other one of the two component parts forms part of or rests at a wall of said outlet channel. The invention also relates to a method of manufacturing such turbo machine.

The present invention relates to turbo machine, e.g., a cryogenic turbo machine, with an impeller mounted on a shaft, an inlet and an outlet for guiding operating fluid, and to a method of manufacturing such turbo machine.

### BACKGROUND

Turbo machines can be used in different applications. For example in cryogenic applications, i.e. applications with process gases at cryogenic temperatures, e.g., plants for air separation or the like, cryogenic turbo machines like turbo expanders and/or compressors are often used. Such turbo machines typically comprise an expander impeller and/or a compressor impeller, which are fixed on a shaft.

Such turbo machines typically also comprise an inlet or inlet channel configured to guide operating fluid, e.g., gas like the mentioned process gas, to such impeller, and an outlet or outlet channel configured to guide said operating fluid, e.g., after expansion, from that impeller, e.g., to the outside. Due to compact construction of such turbo machines, parts of said inlet and outlet, typically, are located quite close to each other, what can lead to heat input from the inlet to the outlet or vice versa, depending on the specific temperatures. It is therefore an object of the present invention to provide an improved turbo machine.

### DISCLOSURE OF THE INVENTION

This object is achieved by providing a turbo machine and a method of manufacturing such a turbo machine with the features of the independent claims. Embodiments of the invention are the subject of the dependent claims and of the description that follows.

The invention relates to turbo machines, in particular cryogenic turbo machines, like turbo compressors or turbo expanders with an impeller arranged or mounted on a shaft. Such turbo machine comprise an inlet (or inlet channel) configured to guide operating fluid, e.g., from an inlet opening, to said impeller, and an outlet or outlet channel configured to guide operating fluid from said impeller, e.g., to an outlet opening. Cryogenic turbo machines are used with operating fluid like gases or process gases at cryogenic temperatures, i.e., very low temperatures of, e.g., less than −100° C. at the expander outlet or at the compressor inlet. Depending on the kind of turbo machine, such gases are compressed and/or expanded. Turbo machines in other applications can also be used with operating fluids at higher temperatures.

Typically, in turbo machines said inlet channel and said outlet channel are arranged such that at least part of a wall of said inlet channel and at least part of a wall of said outlet channel are located close to each other. In many turbo machines, said inlet channel and said outlet channel are arranged such that at least part of one of these two channels surrounds, at least in part, the other one of these two channels. For example, the inlet channel has, at its end, a circular shape that surrounds the outlet channel, which then has a cylindrical or conical shape, e.g., arranged directly next to the impeller.

A typical example for a turbo machine is an expander, in which operating fluid is expanded from high-pressure level at the inlet to low-pressure at the outlet, with a temperature of the operating fluid of, e.g., −100° C. at or in the inlet and of, e.g., −170° C. at the outlet. Thus, a temperature different of about 70° C. between inlet and outlet will be present. Typical turbo machines comprise a simple (thin) plate between inlet and outlet, at least at an area or location where inlet and outlet are close to each other, leading to high heat input from the inlet of the outlet and, thus, reducing efficiency of the turbo machine. It is noted that also for lower temperature differences, heat input arises, what leads to reduced energy (isentropic) efficiency.

It has now been recognized that such heat input can be reduced by providing an insulation component having two component parts separated from each other, at least in part, by a gap. Said two component parts can, in particular, encapsulate a space, which might be evacuated or filled with gas like air or other gas, preferably, a gas of low thermal conductivity.

One of these two component parts forms part of or rests at said wall of said inlet channel, and the other one of these two component parts forms part of, or rests at said wall of said outlet channel. Thus, instead of a simple (thin) plate, such specific insulation component is used to separate the two channels from each other, in particular, where the channels are close to each other. In that case, a (minimal) distance between these two channels is defined by the insulation component or its thickness.

Such assembly of a turbo machine allows creating an isolated space, which will act as insulation. There is, preferably, only static gas remaining inside said space, not moving and creating no convection.

Preferably, said two component parts are formed as individual pieces, preferably, connected or fixed to each other. For example, these two pieces can be centered on one side and connected together on the other side, e.g., through adequate screws. Said thermal insulation space can be modified following the machining of the two pieces.

It is of particular advantage when the turbo machine is configured in a modular fashion, such that said insulation component is exchangeable. This means that said insulation component can be provided only if considered necessary. If no problem with high heat input is expected, the insulation component might be formed from or as a single piece without insulation space, nevertheless having the same outer shape as the insulation component with insulation space has. In addition, another component like said mentioned (thin) plate can be provided instead of said insulation component.

In case that said inlet channel and said outlet channel are arranged such that at least part of one of these two channels surrounds, at least in part, the other one of these two channels, it is of particular advantage when said insulation component has an, at least in part, circular or barrel type or cone shell type shape, preferably arranged around said one of these two channels, which is surrounded by the other one. This allows forming a mutual wall or separating component of said two channels by means of the insulation component for efficiently reducing heat input

### SHORT DESCRIPTION OF THE FIGURES

FIG. 1 illustrates a turbo machine according to a preferred embodiment of the invention.

FIG. 2 illustrates a turbo machine according to a further preferred embodiment of the invention.

FIG. 3 illustrates part of the turbo machine of FIG. 2 in more detail.

FIG. 4 illustrates a manufacturing method according to a preferred embodiment of the invention.

### DETAILED DESCRIPTION OF THE FIGURES

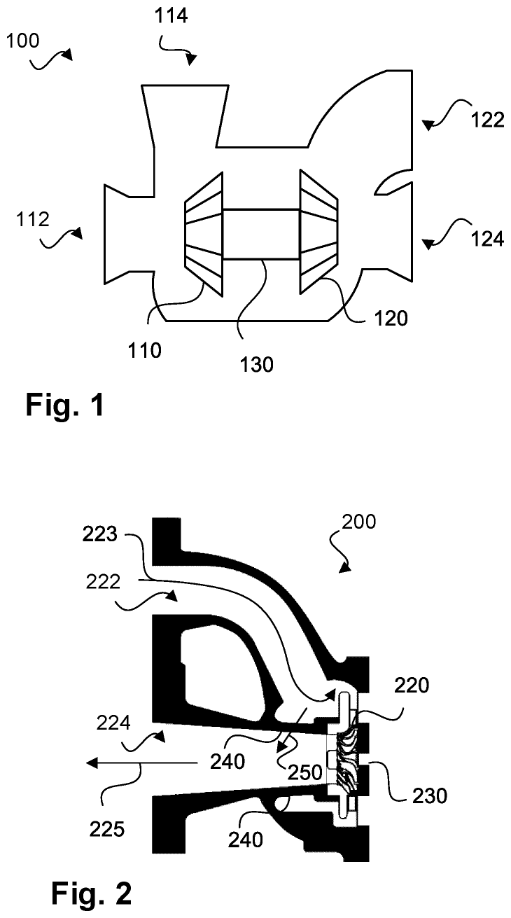

FIG. 1 schematically illustrates a turbo machine 100 according to a preferred embodiment of the invention. The turbo machine 100, e.g., a cryogenic turbo machine is, by means of example, configured as a compressor and an expander, i.e., both are combined in one turbo machine. Turbo machine 100 comprises, hence, two impellers, an impeller 110 and an impeller 120, both mounted on a shaft 130. The turbo machine 100 comprises channels 112 and 114 on the side of the impeller 110, the channels used respectively as inlet channel and outlet channel for the operating fluid to be compressed. The turbo machine 100 further comprises channels 122 and 124 on the side of the impeller 120, the channels used respectively as inlet channel and outlet channel for the operating fluid to be expanded. Thus, the impeller 110 is a compressor impeller and the impeller 120 is an expander impeller. The operating fluid to be compressed and the operating fluid to be expanded can have identical or can have different properties like pressure, temperature, chemical composition etc.

FIG. 2 schematically illustrates a turbo machine 200 according to a further preferred embodiment of the invention e.g., a cryogenic turbo machine, in a cross section. The turbo machine 200 is, by means of example, configured as an expander and as radial turbo machine or radial turbine. It is noted that the parts shown in FIG. 2 can also be combined with compressor parts like shown for turbo machine 100 in FIG. 1. The turbo machine 200 is similar to the expander part of turbo machine 100, however, showing more details.

Turbo machine 200 comprises an impeller 220, mounted on a shaft 230. The turbo machine 200 comprises channels 222 and 224 (with corresponding openings to the outside, shown on the left side) on the side of the impeller 220, the channels used as inlet channel 222 configured to guide operating fluid, that is to be expanded, to the impeller 220 and outlet channel 224 configured to guide operating fluid, that has been expanded, from the impeller 220. An inlet flow of operating fluid is denoted 223, and an outlet flow of operating fluid is denoted 225.

The turbo machine 200 comprises several guide vanes 240 movably arranged therein and arranged in relation to, by means of example, two components in the form of support rings 250 and 252. A channel following the inlet 222 is formed such that the operating fluid (See flow 223) is guided from radial outwards in the direction of the guide vanes 240.

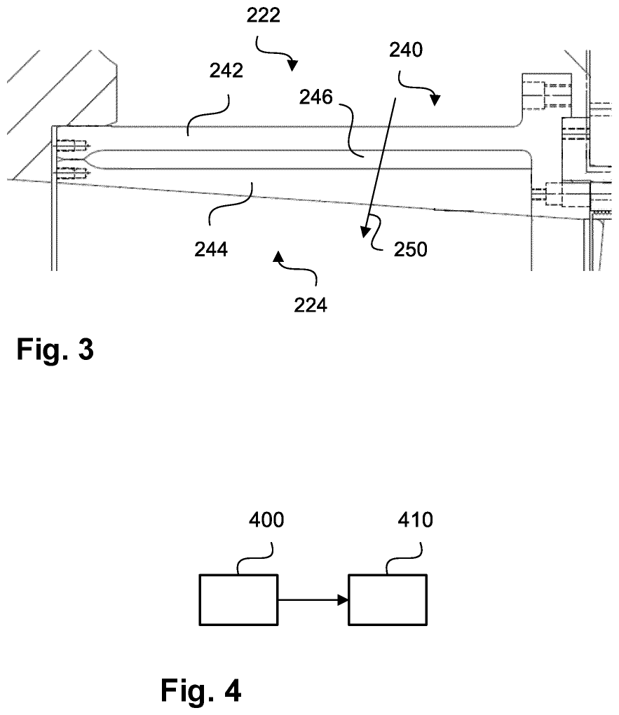

The inlet channel 222 and the outlet channel 224 are arranged such that at least part of a wall of said inlet channel and at least part of a wall of said outlet channel are located close to each other. This, in general, leads to heat input from the channel with warmer operating fluid to the channel with colder operating fluid, the heat input denoted 250. Further, an insulation component 240 is provided, that separates the two channels 222 and 224 from each other, in particular at the location or area where these channels come close to each other. The insulation component will be described in more detail with respect to FIG. 3.

FIG. 3 schematically illustrates the insulation component 240 of the turbo machine 200 in more detail. The insulation component 240 has two component parts 242 and 244, which are separated from each other, at least in part, by a gap. In this way, the two component parts encapsulate a space 246, which might be filled with air or other gas, for example. Component part 242 forms part of a wall of inlet channel 22, and component part 244 forms part of a wall of outlet channel 244.

As can be seen from FIGS. 2 and 3 in combination, component parts 242 and 244 are of essentially barrel type shape, and so is the space 246 in between. In this way, the entire insulation component 240 surrounds the outlet channel 224. The two component parts 242, 244 are configured as two individual pieces centered on one left side (of FIG. 3) and connected together on the right side (of FIG. 3), through adequate screws, as indicated. The space 246 with only static gas remaining inside, not moving and creating no convection reduces the heat input 250 form the warmer inlet channel 222 into the colder outlet channel 224 and, thus, improves efficiency of the turbo machine 200.

FIG. 4 illustrates, by means of a flow diagram, a manufacturing method according to a preferred embodiment of the invention. The method comprises, in a step 400, machining the two component parts, e.g., component parts 242 and 244 as shown in FIG. 3, such that the shape of them corresponds to the shape of at least one of the inlet channel 222 and outlet channel 224. As can be seen in FIGS. 2 and 3, the shape of the inner wall of component part 244, which forms a wall of outlet channel 224, can be of conical shape in order to provide a desired conical shape of outlet channel 224. In a similar way, the other walls of component part 244 and of component part 242 may be formed or machined. In particular, the walls of the component parts forming the space 246 may be formed or machined such that the space has a desired shape. Further, in a step 410, the insulation component 240 is provided in the turbo machine to form an insulation between said inlet channel 222 and said outlet channel 224.

1. A turbo machine with a shaft, an impeller arranged on said shaft, an inlet channel configured to guide operating fluid to said impeller, and an outlet channel configured to guide operating fluid from said impeller,
wherein the turbo machine comprises an insulation component having two component parts separated from each other, at least in part, by a gap, and
wherein one of the two component parts forms part of or rests at a wall of said inlet channel, and the other one of the two component parts forms part of or rests at a wall of said outlet channel.

2. The turbo machine of claim 1, wherein said two component parts separated from each other, at least in part, by said gap encapsulate a space.

3. The turbo machine of claim 2, wherein said space is evacuated or filled with gas.

4. The turbo machine of claim 1, configured in a modular fashion, such that said insulation component is exchangeable.

5. The turbo machine of claim 1, wherein said two component parts are formed as individual pieces, preferably, connected or fixed to each other.

6. The turbo machine of claim 1, wherein said inlet channel and said outlet channel are arranged such that at least part of one of these two channels surrounds, at least in part, the other one of these two channels.

7. The turbo machine of claim 6, wherein said insulation component has an, at least in part, circular or barrel type or cone shell type shape, preferably arranged around said one of these two channels, which is surrounded by the other one.

8. The turbo machine of claim 1, configured as a cryogenic turbo machine.

9. The turbo machine of claim 1, configured as at least one of: a centrifugal turbo machine, a radial turbo machine.

10. The turbo machine of claim 1, configured as at least one of: an expander, a compressor.

11. A method for manufacturing the turbo machine of claim 1, comprising: providing said insulation component in the turbo machine to for an insulation between the inlet channel and the outlet channel.

12. The method of claim 11, wherein said insulation component or at least one of said two component parts is machined such that the shape of it corresponds to the shape of at least one of said inlet channel and outlet channel.
